(19) United States
(12) Patent Application Publication
(10) Pub. No.: US 2026/0305666 A1
(43) Pub. Date: Oct. 8, 2026

(54) SWEETENER COMPOSITIONS

(71) Applicant: CARGILL, INCORPORATED, Wayzata, MN (US)

(72) Inventor: Daniel Scott Gaspard, Victoria, MN (US)

(73) Assignee: CARGILL, INCORPORATED, Wayzata, MN (US)

(21) Appl. No.: 19/482,287

(22) PCT Filed: Apr. 29, 2024
(86) PCT No.: PCT/US2024/026747

§ 371 Date: Nov. 7, 2025

Related U.S. Application Data
(60) Provisional application No. 63/501,029, filed on May 9, 2023.

(51) Int. Cl. A23L 27/30; A23L 2/60

(52) U.S. Cl. CPC A23L 27/36; A23L 2/60

(57) ABSTRACT

A sweetener composition including a sweetening amount of steviol glycoside rebaudioside EE (Reb EE) is provided. Reb EE may be present at a concentration of 0.02-100 wt % by weight of the composition. Reb EE may be included in a food or beverage products or a concentrate. A beverage product or concentrate may include about 1 ppm to about 50,000 ppm of Reb EE. The beverage product or concentrate may include about 50 ppm to about 500,000 ppm of total steviol glycosides. An isolated and purified Reb EE compound may have a purity of about 95% to about 99.9%. Methods for sweetening a food or beverage product using Reb EE are also provided.

### CROSS-REFERENCE TO RELATED APPLICATIONS

This application claims the benefit of U.S. Provisional Application No. 63/501,029, filed May 9, 2023, which is incorporated by reference herein in its entirety.

### BACKGROUND

Within the food and beverage industry, there continue to be efforts to reduce the amount of caloric sugars, such as sucrose, fructose, and/or glucose, in products as consumers continue to seek low-calorie alternatives to calorie-rich products. While sugar substitutes can provide a sweetened taste to products, there may be limitations to preparing products with sugar substitutes. For example, consumers may find that the sensory and temporal characteristics of sugar substitutes differ from those found in caloric sweeteners such as glucose, sucrose, and/or fructose. These sensory characteristics can limit the use of sugar substitutes in products and become increasingly limiting as the concentration of sugar substitute increases.

Steviol glycosides are a class of sweet-tasting glycosylated diterpene compounds commonly obtained from the leaves of Stevia rebaudiana. Various such compounds are known, each having differing properties, taste profiles, and chemical structures. A typical steviol glycoside is characterized by a single steviol backbone and contains one or more carbohydrate residues at C13 and C19. For example, rebaudioside A contains a branched group of three glucosyl groups at C13 and a single β-glucosyl at C19, while rebaudioside D contains the same unit at C13 but a diglucosyl at C19. Steviol glycosides can serve as powerful sweeteners even at low concentrations—providing a sweetening effect approximately 150 to 450 times greater than an equivalent amount of sugar.

Steviol glycosides offer a non-caloric alternative to traditional caloric sweeteners such as sugar, glucose, sucrose, and/or fructose. However, in some cases, consumers may discern that the sensory and temporal taste profile of steviol glycosides differ somewhat from traditional caloric sweeteners. For example, existing steviol glycoside compositions may provide comparably reduced sweetness intensity, increased sweetness linger, increased bitterness, and unfamiliar sensory attributes, such as astringency and metallic tastes, when compared to traditional sweeteners. These sensory attributes can limit the use of steviol glycosides in various consumer products, particularly those which seek to use steviol glycosides in the highest concentrations. At the same time, consumers have favored steviol glycosides as a low-calorie sweetener due, in part, to the fact that such compounds have the potential to be naturally obtained from botanical sources.

Further improvements to sweetener compositions are desired.

### SUMMARY

The present disclosure provides a sweetener composition includes a sweetening amount of rebaudioside EE (Reb EE), wherein Reb EE may be a steviol glycoside compound of Formula I:

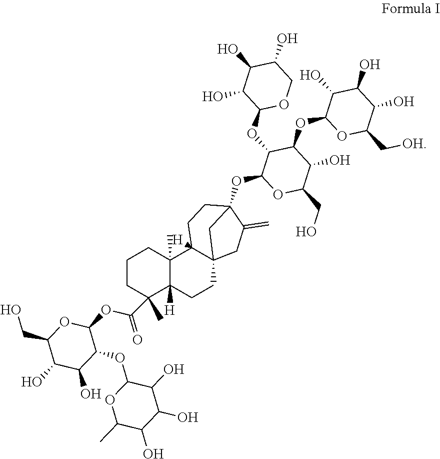 [SMILES: C=C1C[C@@]23CC[C@H]4[C@@](C)(CCC[C@@]4(C)C(=O)O[C@@H]4O[C@H](CO)[C@@H](O)[C@H](O)[C@H]4OC4OC(C)C(O)C(O)C4O)[C@@H]2CC[C@]1(O[C@@H]1O[C@H](CO)[C@@H](O)[C@H](O[C@@H]2O[C@H](CO)[C@@H](O)[C@H](O)[C@H]2O)[C@H]1O[C@@H]1OC[C@@H](O)[C@H](O)[C@H]1O)C3]

Reb EE may be present in the sweetener composition in an amount such that when the sweetener composition may be added to an aqueous solution at a concentration such that the solution includes 500 ppm Reb EE, the solution has a sweetness between 5.0 and 8.0 SEV, between 5.5 and 7.5 SEV, between 6.0 and 7.0 SEV, between 6.25 and 6.75, or about 6.5 SEV. Reb EE may be present in the sweetener composition in an amount suitable to enhance sweetness of a food or beverage composition containing the sweetener composition. The sweetener composition may include about 0.02 weight percent (wt %) to 100 wt %, about 0.04 wt % to 95 wt %, about 0.05 wt % to about 50 wt %, or about 0.05 wt % to about 10 wt % of Reb EE based on total weight of the composition.

The present disclosure provides a food or beverage product containing the sweetener composition described above.

The present disclosure provides a beverage product or concentrate including Reb EE having the structure of Formula I as shown above. The beverage product or concentrate may include about 1 ppm to about 50,000 ppm of Reb EE. The beverage product or concentrate may include about 50 ppm to about 500,000 ppm of total steviol glycosides.

The present disclosure provides a method for sweetening a food or beverage product. The method includes adding Reb EE to the food or beverage product, wherein sweetness of the food or beverage may be higher than sweetness of the food or beverage prior to addition of Reb EE.

The present disclosure provides a method for sweetening a food or beverage product. The method includes adding the sweetener composition described above to the food or beverage product, wherein sweetness of the food or beverage may be higher than sweetness of the food or beverage prior to addition of sweetener composition.

The present disclosure provides a use of the sweetener composition described above to increase the sweetness intensity in a food or beverage product.

The present disclosure provides an isolated and purified steviol glycoside compound (Reb EE), having the structure of Formula I as shown above. The isolated and purified Reb EE compound may have a purity of about 95% to about 99.9%.

The present disclosure provides a composition including Reb EE and at least one additional steviol glycoside.

### BRIEF DESCRIPTION OF FIGURES

The drawings illustrate generally, by way of example, but not by way of limitation, various embodiments discussed herein.

FIG. 1 shows ¹H-NMR NMR spectra of a sample tested in Example 1.

FIG. 2 shows ¹³C-NMR NMR spectra of a sample tested in Example 1.

FIG. 3 shows a summary of NMR results of a sample tested in Example 1.

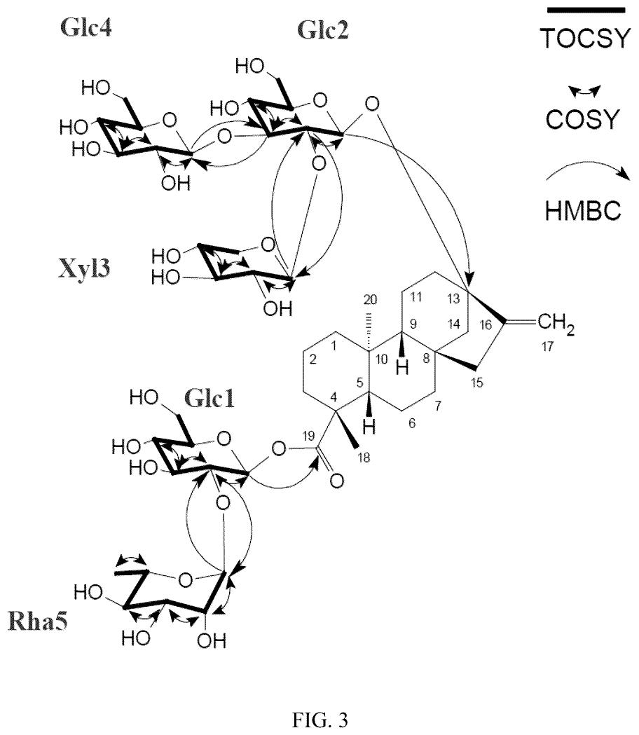

It should be understood that numerous other modifications and examples can be devised by those skilled in the art, which fall within the scope and spirit of the principles of this disclosure.

### DETAILED DESCRIPTION

This disclosure relates to various compositions, such as sweetener compositions and other compositions, and in particular, steviol glycoside compositions which have improved sensory attributes, such as reduced bitterness and/or reduced off-taste(s).

All scientific and technical terms used herein have meanings commonly used in the art unless otherwise specified. The definitions provided herein are to facilitate understanding of certain terms used frequently herein and are not meant to limit the scope of the present disclosure.

The term “about” is used here in conjunction with numeric values to include normal variations in measurements as expected by persons skilled in the art and is understood to have the same meaning as “approximately” and to cover a typical margin of error, such as +5% of the stated value.

Terms such as “a,” “an,” and “the” are not intended to refer to only a singular entity but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5% 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

As used here, “have,” “having,” “include,” “including.” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

### Steviol Glycosides

The present disclosure provides compositions containing a steviol glycoside component or a mixture of a variety of steviol glycosides. According to embodiments, the compositions include rebaudioside EE (Reb EE). The compositions may optionally include other steviol glycosides. The compositions may optionally include other additional components.

The steviol glycoside component can include one or more steviol glycosides. In some aspects, the term steviol glycoside refers to rebaudioside A (Reb A) (CAS #58543-16-1), rebaudioside B (Reb B) (CAS #58543-17-2), rebaudioside C (Reb C) (CAS #63550-99-2), rebaudioside D (Reb D) (CAS #63279-13-0), rebaudioside E (Reb E) (CAS #63279-14-1), rebaudioside EE (Reb EE), rebaudioside F (Reb F) (CAS #438045-89-7), 1.3-stevioside (rebaudioside G or Reb G), rebaudioside I (Reb I) (MassBank Record: FU000332), rebaudioside J (Reb J) (CAS #1313049-59-0), rebaudioside M (Reb M) (CAS #1220616-44-3), rebaudioside N (Reb N), rebaudioside 0 (Reb O) (CAS #1220616-48-7), rebaudioside Q (Reb Q), rebaudioside V2 (Reb V2), rebaudioside DG (Reb DG), rubusoside (CAS #63849-39-4), dulcoside A (CAS #64432-06-0), stevioside, 1,2-stevioside (CAS #57817-89-7), steviolmonoside, steviol-13-monoside, steviol-19-monoside, steviolbioside, steviol-1,2-bioside (MassBank Record: FU000299), steviol-1,3-bioside, steviol-13-O-glucoside (13-SMG), steviol-19-O-glucoside (19-SMG), OPSI-5 (corresponding to compound 4 from WO2016100689), 13-[(3-D-glucopyranosyl)oxy)kaur-16-en-18-oic acid 2-O-β-D-glucopyranosyl-β-D-glucopyranosyl ester, steviol glycosides with 1, 2, 3, 4, 5, 6, 7, 8, 9, 10 or more glycosides, and isomers thereof. Further discussion of steviol glycosides can be found in Harriet Wallin et al., Steviol Glycosides, 84th JECFA—Chemical and Technical Assessment (2017) Food Agric. Org. Rebaudiosides can be used in commercially available form, obtainable from Cargill, Inc. (Wayzata, MN). Rebaudiosides can be isolated and purified before use.

Steviol glycosides are sometimes used as blends, such as blends of Reb D and Reb M. Such blends may be notated as “rebaudioside D/M” or “Reb D/M”, and may include the two rebaudiosides, their related isomers (e.g., natural or synthetic), and/or salts thereof. This terminology format may be used for compositions having any other combination of glycosides, for example, but not limited to Reb D/G, Reb D/M/O, Reb N/O, Reb D/E, and the like.

Structurally, steviol glycosides comprise a steviol backbone and differ by the presence and arrangement of carbohydrate residues at the C13 and C19 positions of the steviol backbone, according to the atom numbering on the base shown below. The glucopyranosyl residues represent groups R₁ and R₂ in the following formula:

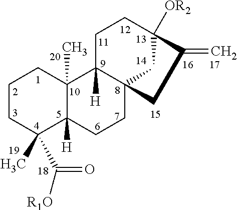

Not only do steviol glycosides differ structurally, but the various steviol glycosides also have differing physical and sensory properties. Steviol is represented by the above formula when R₁ and R₂ are hydrogen. Steviol glycosides generally have the formula shown above where steviol is the aglycone backbone and R₁ and R₂ can each be hydrogen or one or more sugar moieties. These sugar moieties are most commonly glucose, rhamnose, or xylose, but steviol glycosides have been reported that include fructose and deoxyglucose sugar moieties. Table below shows the various steviol glycosides and the corresponding R₁ and R₂ groups:

TABLE 1

| Compound name | R₁ (C-19) | R₂ (C-13) |
|---|---|---|
| Steviol | H | H |
| Stevioside | Glcβ1- | Glcβ(1-2)Glcβ1- |
| Rebaudioside A | Glcβ1- | Glcβ(1-2)[Glcβ(1-3)]Glcβ1- |
| Rebaudioside B | H | Glcβ(1-2)[Glcβ(1-3)]Glcβ1- |
| Rebaudioside C | Glcβ1- | Rhaα(1-2)[Glcβ(1-3)]Glcβ1- |
| Rebaudioside D | Glcβ(1-2)Glcβ1- | Glcβ(1-2)[Glcβ(1-3)]Glcβ1- |
| Rebaudioside E | Glcβ(1-2)Glcβ1- | Glcβ(1-2)Glcβ1- |
| Rebaudioside G | Glcβ1- | Glcβ(1-3)Glcβ1 |
| Rebaudioside J | Rhaα(1-2)Glcβ1- | Glcβ(1-2)[Glcβ(1-3)]Glcβ1- |
| Rebaudioside M | Glcβ(1-2)[Glcβ(1-3)]Glcβ1- | Glcβ(1-2)[Glcβ(1-3)]Glcβ1- |
| Rebaudioside N | Rhaα(1-2)[Glcβ(1-3)]Glcβ1- | Glcβ(1-2)[Glcβ(1-3)]Glcβ1- |
| Rebaudioside O | Glcβ(1-3)Rhaα(1-2)[Glcβ(1-3)]Glcβ1- | Glcβ(1-2)[Glcβ(1-3)]Glcβ1- |
| Rebaudioside Q | Glcβ1- | Glaα1-4)Glcβ(1-2)[Glcβ(1- |
| | | 3)]Glcβ1- |
| Rebaudioside V2 | Xylβ (1-2)[Glcβ(1-3)]Glcβ1- | Glcβ(1-2)[Glcβ(1-3)]Glcβ1- |

Glu: glucose;
Rha: rhamnose;
Xyl: xylose

Not only do steviol glycosides differ structurally, but the various steviol glycosides can also differ in their sensory properties. For example, stevioside (comprising three glucose units) and rebaudioside A (comprising four glucose units) are found in greater abundance in Stevia extracts and have particular sweetness attributes. Both stevioside and rebaudioside A add sweetness but can also be perceived as exhibiting bitterness attributes, especially at higher concentrations. Rebaudioside A exhibits bitterness attributes that increase with concentration and that can limit its use at higher concentrations (e.g., greater than 400 ppm).

Other steviol glycosides can include increased numbers of glycosides and are found in much lower abundance in Stevia extracts. Such compounds can sometimes be termed “minor” steviol glycosides, even when they are used as a primary component in a composition. For example, so-called minor steviol glycosides can include rebaudioside D and rebaudioside M, which are found in lower abundance in Stevia extracts and comprise different sweetness attributes than the more abundant steviol glycosides. Some of the sweetness attributes of these minor steviol glycosides can be preferred over the major steviol glycosides. For example, rebaudioside D and rebaudioside M exhibit reduced bitterness attributes compared to rebaudioside A. These reduced bitterness attributes of rebaudioside D and rebaudioside M permit a more favorable sensory experience and enable their use at higher concentrations. However, although bitterness is reduced in rebaudioside D and rebaudioside M compared to rebaudioside A, the perception of bitterness can still be limiting, especially at higher concentrations. Other sensory attributes can also be limiting, for example sweetness linger can be limiting in these minor glycosides, especially at higher concentrations. Sweetness linger can be perceived as a sweetness that lingers in the mouth longer than what is expected with a comparable sugar solution. Sweetness linger of minor steviol glycosides can limit their use, especially at higher concentrations.

### Rebaudioside EE

In some embodiments, the present disclosure relates to an isolated and purified steviol glycoside compound Rebaudioside EE having the structure of Formula I.

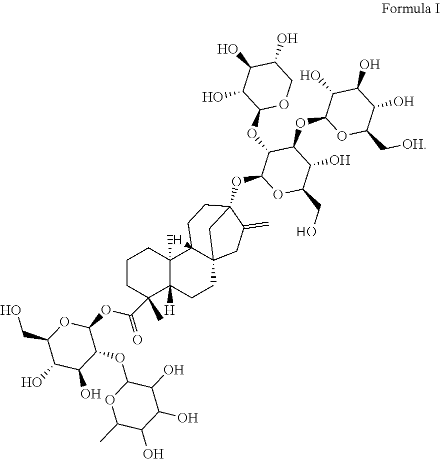 [SMILES: C=C1C[C@@]23CC[C@H]4[C@@](C)(CCC[C@@]4(C)C(=O)O[C@@H]4O[C@H](CO)[C@@H](O)[C@H](O)[C@H]4OC4OC(C)C(O)C(O)C4O)[C@@H]2CC[C@]1(O[C@@H]1O[C@H](CO)[C@@H](O)[C@H](O[C@@H]2O[C@H](CO)[C@@H](O)[C@H](O)[C@H]2O)[C@H]1O[C@@H]1OC[C@@H](O)[C@H](O)[C@H]1O)C3]

The isolated and purified Reb EE may have a purity of 90% or greater, 95% or greater, or 99% or greater. The isolated and purified Reb EE may have a purity of 100% or lower, 99.9% or lower. 99.5% or lower, 99% or lower, 98% or lower, or 95% or lower. The isolated and purified Reb EE may have a purity of about 95% to about 99.9%.

### Compositions

The compositions discussed herein may be sweetener compositions or other compositions, such as foodstuffs, including Reb EE. While the following discussion references sweetener compositions, it should be understood that the discussion applies to other compositions, as well, whether or not they would be considered sweetener compositions.

As used herein, “sugar substitute” refers to a low-calorie sweetener or a no-calorie sweetener.

As used herein. “low-calorie sweetener” refers to sweeteners that have the same or lower intensity of sweetness per gram than sucrose but fewer calories. For example, suitable low-calorie sweeteners may include, but are not limited to, erythritol, arabitol, isomalt, tagatose, erythritol, maltitol, lactitol, sorbitol, mannitol, allulose, allose, sorbose, xylitol, hydrogenated starch hydrolysates, combinations thereof, and the like. Preferably, the low-calorie sweetener is a sugar alcohol or rare sugar.

As used herein, “no-calorie sweetener” refers to sweeteners that have no calories, or do not add calories to the compositions to which they are added due to their low usage levels, but have higher intensity of sweetness per gram than sucrose. No-calorie sweeteners may also be known in the art as high intensity sweeteners or high potency sweeteners. No-calorie sweeteners may include, but are not limited to, steviol glycosides, mogrosides, sucralose, acesulfame potassium (acesulfame K), aspartame, saccharin, brazzein, combinations thereof, and the like.

As used herein, “caloric sweeteners” refer to ingredients that add both sweetness and calories to the compositions to which they are added. Caloric sweeteners include, but are not limited to, trehalose, glucose, dextrose, fructose, galactose, sucrose, lactose, maltose, palatinose, isomaltulose, cane sugar, beet sugar, rice syrup, invert sugar, honey, agave syrup, maple syrup, high fructose corn syrup, combinations thereof, and the like. The term “sucrose” as used herein includes sucrose in various forms including but not limited to standard (e.g., granulated or crystalline) table sugar, powdered sugar, caster sugar, icing sugar, sugar syrup, silk sugar, unrefined sugar, raw sugar cane, and molasses.

According to an embodiment, a composition or sweetener composition of the present disclosure includes rebaudioside EE (Reb EE). The sweetener composition may include Reb EE with one or more additional steviol glycosides. The one or more additional steviol glycosides may be selected from steviolmonoside, steviolbioside, stevioside, rebaudioside A (Reb A), rebaudioside B (Reb B), rebaudioside C (Reb C), rebaudioside D (Reb D), rebaudioside DG (Reb DG), rebaudioside E (Reb E), rebaudioside F (Reb F), rebaudioside J (Reb J), rebaudioside M (Reb M), rebaudioside N (Reb N), rebaudioside O (Reb O), rebaudioside V2 (Reb V2), rubusoside, dulcoside A, steviol-13-monoside, steviol-19-monoside, 13-[(β-D-glucopyranosyl)oxy)kaur-16-en-18-oic acid 2-O-β-D-glucopyranosyl-β-D-glucopyranosyl ester, and combinations of two or more thereof.

According to an embodiment, the sweetener composition including Reb EE has a sweetness level that is similar to sweeteners made with Reb A. The sweetener composition has pleasing sensory attributes and reduced off-taste(s), reduced bitterness, or both reduced off-taste(s) and reduced bitterness.

The sweetener composition may be formulated as a concentrate, as a sweetener, or as part of a food product. Reb EE may be present in the sweetener composition at any suitable concentration. Reb EE may be present in the sweetener composition suitable to enhance sweetness of a food or beverage composition containing the sweetener composition. Reb EE may be present in the sweetener composition in an amount such that when the sweetener composition is added to an aqueous solution at a concentration such that the solution includes 500 ppm Reb EE, the solution has a sweetness of 4.0 SEV or greater, 4.5 SEV or greater, 5.0 SEV or greater, 5.5 SEV or greater, 6.0 or greater, 6.25 or greater, or about 6.5 SEV or greater. Reb EE may be present in the sweetener composition such that the resulting solution that includes 500 ppm Reb EE has a sweetness of 8.0 SEV or lowers, 7.5 SEV or lower, 7.0 SEV or lower, 6.75 or lower, or about 6.5 or lower. Reb EE may be present in the sweetener composition such that the resulting solution that includes 500 ppm Reb EE has a sweetness between 5.0 and 8.0 SEV, between 5.5 and 7.5 SEV, between 6.0 and 7.0 SEV, between 6.25 and 6.75, or about 6.5 SEV.

In some embodiments, the sweetener composition includes about 0.02 weight percent (wt %) or more, 0.04 wt % or more, 0.05 wt % or more, 0.1 wt % or more, 0.2 wt % or more, 0.5 wt % or more, or 1 wt % or more of Reb EE based on the total weight of the sweetener composition. The sweetener composition may include about 100 wt % or less, 98 wt % or less, 95 wt % or less, 90 wt % or less, 80 wt % or less, 70 wt % or less, 60 wt % or less, 50 wt % or less, 40 wt % or less, 30 wt % or less, or 20 wt % or less of Reb EE based on the total weight of the sweetener composition. The sweetener composition may include about 0.02 weight percent (wt %) to 100 wt %, about 0.04 wt % to 95 wt %, comprises about 0.05 wt % to about 50 wt %, or about 0.05 wt % to about 10 wt % of Reb EE based on the total weight of the sweetener composition.

The sweetener composition may include various amounts of additional steviol glycosides in addition to Reb EE. Steviol glycosides may be present in the composition in any amount desired for the intended use or for an intended or desired flavor profile, taste profile (e.g., off tastes or lack thereof, bitterness, sourness, umami, etc.), or sweetness profile (e.g., level of sweetness, temporal aspects of sweetness). Examples of additional steviol glycoside compounds that may be included in the sweetener composition in addition to Reb EE include steviolmonoside, steviolbioside, stevioside, rebaudioside A (Reb A), rebaudioside B (Reb B), rebaudioside C (Reb C), rebaudioside D (Reb D), rebaudioside DG (Reb DG), rebaudioside E (Reb E), rebaudioside F (Reb F), rebaudioside J (Reb J), rebaudioside M (Reb M), rebaudioside N (Reb N), rebaudioside O (Reb O), rebaudioside V2 (Reb V2), rubusoside, dulcoside A, steviol-13-monoside, steviol-19-monoside, 13-[(β-D-glucopyranosyl)oxy)kaur-16-en-18-oic acid 2-O-β-D-glucopyranosyl-β-D-glucopyranosyl ester, and combinations of two or more thereof. In some embodiments, the sweetener composition includes Reb EE in combination with one or more additional steviol glycoside compounds selected from the group consisting of Reb A, Reb D, Reb DG, Reb J, Reb M, Reb N, Reb O, Reb V2, and combinations thereof. In some embodiments, the sweetener composition includes Reb EE in combination with one or more additional steviol glycoside compounds selected from the group consisting of Reb D, Reb J, Reb M, Reb O, and Reb V2. In some embodiments, the sweetener composition includes Reb EE in combination with one or more additional steviol glycoside compounds selected from the group consisting of Reb D. Reb M, and combinations thereof.

In some embodiments, Reb EE makes up the entire steviol glycoside content of the sweetener composition. In other embodiments, Reb EE is present in an amount of about 0.5 wt % or greater, 1 wt % or greater, 2 wt % or greater, 5 wt % or greater, 10 wt % or greater, 25 wt % or greater, or 50 wt % or greater based on the total amount of steviol glycosides in the sweetener composition. Reb EE may be present in an amount of about 100 wt % or less, 90 wt % or less, 80 w-t % or less, 70 wt % or less, 60 wt % or less, 50 wt % or less, 40 wt % or less, 30 wt % or less, 20 wt % or less, 10 wt % or less, or 5 wt % or less based on the total amount of steviol glycosides in the sweetener composition. Reb EE may be present in an amount of is present in an amount of about 0.5 wt % to 100 wt % or about 0.5 wt % to about 10 wt % based on the total amount of steviol glycosides in the sweetener composition.

The one or more additional steviol glycosides, if included, may be present in an amount of 0.1 wt % or greater, 0.2 wt % or greater, 0.5 wt % or greater. 1 wt % or greater. 2 wt % or greater, 5 wt % or greater, 10 wt % or greater, 25 wt % or greater, 30 wt % or greater, 40 wt % or greater, 50 wt % or greater, 60 wt % or greater, 70 wt % or greater, 80 wt % or greater, or 90 wt % or greater based on the total amount of steviol glycosides in the sweetener composition. The one or more additional steviol glycosides may be present in an amount of 99.5 wt % or less, 98 wt % or less, 95 wt % or less, 90 wt % or less, 80 wt % or less, 70 wt % or less, 60 wt % or less, 50 wt % or less, 40 wt % or less, 30 wt % or less, 20 wt % or less, 10 wt % or less, or 5 wt % or less based on the total amount of steviol glycosides in the sweetener composition. The one or more additional steviol glycosides may be present in an amount of 0.1 wt % to about 99.5 wt % based on the total amount of steviol glycosides in the sweetener composition.

The total amount of steviol glycosides in the sweetener composition may be 0.5 wt % or greater, 1 wt % or greater, 2 wt % or greater, 5 wt % or greater, 10 wt % or greater, 20 wt % or greater, 30 wt % or greater, 40 wt % or greater, 50 wt % or greater, 60 wt % or greater, 70 wt % or greater, 80 wt % or greater, 90 wt % or greater, or 95 wt % or greater based on the weight of the sweetener composition. The total amount of steviol glycosides in the sweetener composition may be about 100 wt % or less, 90 wt % or less, 80 wt % or less, 70 wt % or less, 60 wt % or less. 50 wt % or less, 40 wt % or less, 30 wt % or less, 20 wt % or less, 10 wt % or less, or 5 wt % or less based on the weight of the sweetener composition. The total amount of steviol glycosides in the sweetener composition may be 0.5 wt % to 100 wt %, 1 wt % to 90 wt %, or 1 wt % to 50 wt % based on the weight of the sweetener composition.

In some embodiments, the sweetener composition is an aqueous solution containing Reb EE. The amount of Reb EE in the sweetener composition may be 1 ppm or greater, 5 ppm or greater, 10 ppm or greater, 50 ppm or greater, 100 ppm or greater, 500 ppm or greater, 1,000 ppm or greater, 5,000 ppm or greater, or 10,000 ppm or greater. The amount of Reb EE in the sweetener composition may be 100,000 ppm or less, 50,000 ppm or less. 30.000 ppm or less, 20,000 ppm or less, 10,000 ppm or less, 8,000 ppm or less, 5,000 ppm or less, 2,000 ppm or less, or 1,000 ppm or less. The composition may include Reb EE at a concentration of 1 ppm to 100,000 ppm, 1 ppm to 50,000 ppm, 1 ppm to 30,000 ppm, or 5 ppm to 10,000 ppm.

In some embodiments, the sweetener composition is an aqueous solution containing one or more steviol glycosides and including Reb EE. The total amount of steviol glycosides in the sweetener composition may be 1 ppm or greater, 5 ppm or greater, 10 ppm or greater, 50 ppm or greater, 100 ppm or greater, 500 ppm or greater, 1,000 ppm or greater, 5,000 ppm or greater, 10,000 ppm or greater, 50,000 ppm or greater, 100,000 ppm or greater, or 200,000 ppm or greater. The amount of steviol glycosides in the sweetener composition may be 500,000 ppm or less, 400,000 ppm or less, 300,000 ppm or less, 200,000 ppm or less, 100,000 ppm or less, 50,000 ppm or less, 30,000 ppm or less, 20,000 ppm or less, 10,000 ppm or less, 8,000 ppm or less, 5,000 ppm or less, 2,000 ppm or less, or 1,000 ppm or less. The composition may include steviol glycosides at a concentration of 1 ppm to 500,000 ppm, 1 ppm to 300,000 ppm, 1 ppm to 100,000 ppm, 1 ppm to 50,000 ppm, 1 ppm to 30,000 ppm, or 5 ppm to 10,000 ppm.

In some embodiments, the sweetener composition is added to an aqueous solution at a concentration such that the solution comprises 400 ppm Reb EE, the solution has i) reduced bitterness relative to an equivalent solution prepared with Reb A; ii) reduced metallic notes relative to an equivalent solution prepared with Reb M; and/or iii) reduced sweetness linger relative to an equivalent solution prepared with a combination of Reb D and Reb M.

The sweetener composition may exhibit reduced bitterness compared to equivalent compositions prepared with Reb A. The sweetener composition may exhibit reduced metallic notes compared to equivalent compositions prepared with Reb M. The sweetener composition may exhibit reduced sweetness linger compared to equivalent compositions prepared with a combination of Reb D and Reb M. In some embodiments, when the sweetener composition is added to an aqueous solution at a concentration such that the aqueous solution includes 400 ppm Reb EE, the solution has i) reduced bitterness relative to an equivalent compositions prepared with Reb A: ii) reduced metallic notes relative to an equivalent compositions prepared with Reb M; and/or iii) reduced sweetness linger relative to an equivalent compositions prepared with a combination of Reb D and Reb M.

### Additional Components

In addition to the steviol glycoside(s), the sweetener composition may additionally include one or more bulking agents, plasticizers, emulsifiers, flavorings, or combinations thereof.

Suitable bulking agents include oligosaccharides (such as fructo-oligosaccharides (kestose, nystose, and the like), nigero-oligosaccharides, xylo-oligosaccharides (xylotriose, xylobiose and the like), gentio-oligosaccharides (gentiobiose, gentiotriose, gentiotetraose, and the like), galacto-oligosaccharides, tetrasaccharides, mannan-oligosaccharides, malto-oligosaccharides (maltotriose, maltotetraose, maltopentaose, maltohexaose, maltoheptaose, and the like), soybean oligosaccharides, and the like), polysaccharides (such as starch and starch-derivatives including maltodextrin, dextrins, and glucose syrup; fructan; inulin; polydextrose; pectin, and the like), insoluble fibers (such as resistant starches, cereal fibers, grain fibers, fruit fibers, and legume fibers), sugar alcohols (such as erythritol, maltitol, lactitol, sorbitol, mannitol, xylitol), rare sugars (such as allulose, tagatose, and the like) and combinations thereof. In some embodiments, the bulking agent may include vegetable fibers, dextrin, maltodextrin, polydextrose, inulin, dehydrated grain syrups (such as dried rice syrup), pectin, sugar alcohols, or a combination of two or more thereof. In some embodiments, the bulking agent is a sugar alcohol. Bulking agents may be added to the sweetener composition in an amount of up to 75%, up to 70%, up to 65% up to 60% up to 55% up to 50%, up to 45%, up to 40%, up to 35%, up to 30% up to 25%, up to 20%, up to 15%, or up to 10% by weight of the sweetener composition. The sweetener composition may include a bulking agent in an amount of 0.5% to 75%, 1% to 60%, 2% to 55%, or 3% to 50% by weight. In some cases, an ingredient may function as both a sweetener and a bulking agent in a sweetener composition. Examples of such bulking agents include erythritol, maltitol, lactitol, sorbitol, mannitol, xylitol, allulose, and tagatose.

In some embodiments, the sweetener composition also contains one or more additional non-steviol glycoside sweetener compounds. The sweetener composition may include only non-caloric sweeteners. Alternatively, the sweetener composition may include a combination of non-caloric and caloric sweeteners. The additional non-steviol glycoside sweetener compounds can be any type of sweetener, for example, a sweetener obtained from a plant or plant product, or a physically or chemically modified sweetener obtained from a plant, or a synthetic sweetener. Exemplary non-steviol glycoside sweeteners that may be included in the sweetener composition include sucrose, fructose, glucose, erythritol, maltitol, lactitol, sorbitol, mannitol, xylitol, tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligosaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, sucralose, isomerized liquid sugars such as high fructose corn/starch syrup (HFCS/HFSS) (e.g.. HFCS55. HFCS42, or HFCS90), coupling sugars, soybean oligosaccharides, glucose syrup, and combinations thereof. Either D- or L-configurations or both can be used when applicable. Non-steviol glycoside sweeteners and aspects thereof are also described in PCT International Publication Nos. WO 2019/071220 and WO 2019/071182 and in US Patent Application Publication Nos. 2019/0223481 and 2019/0223483, each of which is incorporated by reference herein in its entirety.

In various embodiments, the sweetener composition may further optionally include a liquid carrier, binder matrix, additional additives, and/or the like. In some embodiments the sweetener composition contains one or more additives including carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers or combinations thereof. In some embodiments, the additives act to improve the temporal and flavor profile of the sweetener to provide a sweetener composition with a favorable taste, such as a taste similar to sucrose. Examples of such ingredients and aspects thereof are described, for example, in PCT International Publication Nos. WO 2019/071220 and WO 2019/071182 and in US Patent Application Publication Nos. 2019/0223481 and 2019/0223483, each of which is incorporated by reference herein in its entirety.

### Food Products

The sweetener composition may be incorporated in or used to prepare any known edible material or other composition intended to be ingested and/or contacted with the mouth of a human or animal, such as, for example, pharmaceutical compositions, supplement compositions (e.g., gummy, tablet, etc.), edible gel mixes and compositions, dental and oral hygiene compositions, foodstuffs (e.g., confections, condiments, chewing gum, cereal compositions, baked goods, baking goods, cooking adjuvants, dairy products, and tabletop sweetener compositions), and beverage products (e.g., beverages, beverage mixes, beverage concentrates, etc.). Examples of such compositions and aspects thereof are set forth in PCT International Publication Nos. WO 2019/071220 and WO 2019/071182 and in US Patent Application Publication Nos. 2019/0223481 and 2019/0223483, each of which is incorporated by reference herein in its entirety.

The sweetener composition may be a beverage product or can be used to prepare a beverage product. As used herein a “beverage product” may be a ready-to-drink beverage, a beverage concentrate, a beverage syrup, frozen beverage, a powdered beverage, or the like. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts, smoothies and combinations thereof. Examples of frozen beverages include, but are not limited to, icees, frozen cocktails, daiquiris, pina coladas, margaritas, milk shakes, frozen coffees, frozen lemonades, granitas, and slushees. Beverages may be alcoholic (e.g., a liqueur or cream liqueur) or non-alcoholic beverages. The beverage may be a brewed for fermented beverage, for example, beer or kombucha. Beverage concentrates and beverage syrups can be prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water, liquid matrix, or aqueous solution.

The sweetener composition can be a food product or can be used to prepare a food product. The food product may be any caloric or non-caloric food product suitable for human consumption. Suitable food products include, but are not limited to, confectionary products (e.g., candies, candied nuts, candy bars, caramels, chocolates, chocolate bars, chocolate drops, chocolate in the form of hollow figures or any desired shape, filled chocolate bars, pralines, truffles, cereal bars, chewing gum, and pastillage), condiments, chewing gum, cereal compositions, baked goods, bakery products (e.g., breads such as bagels, buns, rolls, biscuits and loaf breads; cookies; brownies: muffins; desserts such as cakes, cheesecakes and pies; snack cakes; sweet goods such as doughnuts, Danish pastries, sweet rolls, cinnamon rolls, and coffee cakes), cooking adjuvants, dairy products (e.g., ice cream, yogurt, chilled desserts, pudding, mousse, custard, milk shakes, malts, cream cheeses, cheeses, fudge), dairy-alternatives, frozen desserts (e.g., ice cream, sorbet, frozen yoghurt, and the like), tabletop sweetener compositions, seasoning, sauces, gravies, soups, dressings, snack products (e.g., granola bars, nutrition bars, and the like), and the like. The compositions described herein may be used in food products in any form, such as melted or mixed into the recipe of the end product, in the form of a filling, inclusions, toppings, or coatings, molded around other discrete ingredients such as nuts, fruit, dried fruit, biscuits, candy pieces or shapes, combinations thereof, and the like. In frozen dessert compositions, the composition may be used as a coating, inclusion (chunks, flakes, or ripples), topping, or core (soft or solid).

In some embodiments, the Reb EE is included in a beverage product or concentrate. That is, a beverage product or concentrate may include Reb EE (having the structure of Formula I as shown above). The beverage product or concentrate may include total steviol glycosides at a concentration of 50 ppm or greater, 100 ppm or greater, 500 ppm or greater, 1.000 ppm or greater, 5,000 ppm or greater, 10,000 ppm or greater, 50,000 ppm or greater, 100,000 ppm or greater, or 200,000 ppm or greater. The amount of steviol glycosides in the beverage product or concentrate may be 500,000 ppm or less, 400,000 ppm or less, 300,000 ppm or less, 200,000 ppm or less, 100,000 ppm or less, 50,000 ppm or less, 30,000 ppm or less, 20,000 ppm or less, 10,000 ppm or less, 8,000 ppm or less, 5,000 ppm or less, 2,000 ppm or less, or 1,000 ppm or less. The beverage product or concentrate may include steviol glycosides at a concentration of 1 ppm to 500,000 ppm, 1 ppm to 300,000 ppm, 1 ppm to 100,000 ppm, 1 ppm to 50,000 ppm, 1 ppm to 30.000 ppm, or 5 ppm to 10.000 ppm.

In some embodiments, a method of preparing a beverage provided herein includes adding a sweetener composition as described herein to a liquid matrix (e.g., water or an aqueous solution). The method can further comprise adding one or more sweeteners, additives and/or functional ingredients to the beverage or to the composition before adding it to the liquid matrix.

A method of sweetening a food or beverage product may include adding Reb EE to the food or beverage product, where the sweetness of the food or beverage is higher than the sweetness of the food or beverage prior to addition of Reb EE. The method of sweetening the food or beverage product may include adding a sweetener composition containing Reb EE to the food or beverage product, where the sweetness of the food or beverage is higher than the sweetness of the food or beverage prior to addition of the sweetener composition.

### Sensory Attributes

The sweetener composition may be formulated to provide desirable sensory attributes, such as perceived sweetness, little or no bitterness, minimal or no off-taste(s), and temporal profiles of the same, including, for example, sweetness linger. Sensory attributes may be evaluated, for example, by a sensory panel.

As used herein, “taste” refers to sensory perception on the tongue. For example, the 5 basic tastes are sweet, sour, salty, bitter, and umami.

As used herein, “aroma” refers to the orthonasal perception in the nasal cavity.

As used herein, “flavor” refers to the taste and retronasal perception in the nasal cavity.

As used herein, “off-taste(s)” refer to a taste or flavor attribute profile that is not characteristic or usually associated with a substance or composition as described herein and/or a characteristic taste or flavor associated with a substance or composition that is undesirable. For example, the off-taste may be an undesirable taste such as bitterness, undesirable mouthfeel such as astringency, mouth drying, undesirable flavor such as rancid, cardboard, aftertaste, inconsistent flavor (e.g., a flavor with an uneven onset or intensity, a flavor that may be perceived too early or too late), and the like.

Sweetness of a compound or composition may be determined by measuring sucrose equivalent values (SEV) using methods and processes well known to those skilled in the art. SEV may be determined by measuring sweetness equivalence to a reference sucrose solution or to another compound with a known sweetness level. For example, sweetness may also be measured or observed relative to other steviol glycosides, such as rebaudioside D, rebaudioside M, or rebaudioside A. Typically, taste panelists are trained to detect and scale sweetness of reference sucrose solutions containing between 10 g to 150 g/kg sucrose. The sweetener compositions containing the glycosides are then tasted at a series of dilutions to determine the concentration of the sweetener composition that is as sweet as a given sucrose reference. For example, if a sweetener composition is as sweet as 50 g/kg of sucrose solution in a citric acid buffer. pH 3.1, then the sweetener composition is assigned a SEV of 5. The term “sweetness value” is used interchangeably herein with “SEV”.

Bitterness of a compound or composition may be determined by measuring caffeine equivalent values using methods and processes well known to those skilled in the art. For example, bitterness may be determined by measuring bitterness equivalence to a reference caffeine solution or to another compound with a known bitterness level. Bitterness may also be measured or observed relative to other steviol glycosides, such as rebaudioside D, rebaudioside M, or rebaudioside A. Typically, taste panelists are trained to detect and scale bitterness of reference caffeine solutions containing between 0.1 g to 0.8 g/kg caffeine. The sweetener compositions containing the glycosides are then tasted at a series of dilutions to determine the concentration of the sweetener composition that is as bitter as a given caffeine reference. For example, if a sweetener composition is as bitter as 0.3 g/kg of caffeine solution, then the sweetener composition is assigned a bitterness of 5.

In some aspects, minor steviol glycosides, including Reb EE, may exhibit specific sensory attributes related to sweetness intensity. Perceived sweetness intensity can be reported as SEV. While perception of sweetness intensity generally increases as the concentration of the minor steviol glycoside increases, the perceived sweetness intensity can reach a plateau despite increasing amounts of the minor steviol glycoside. In some cases, the sweetener composition may include sensory modifiers that may be used to increase the perceived sweetness intensity of minor steviol glycosides. Sensory modifiers are further discussed in PCT/US2020/026524, published as WO2020210118.

A sensory panel may be used to determine the magnitude of, for example, sweetness intensity, reduction in bitterness, or shifts in their temporal profiles. A sensory panel may be used to quantify the amounts of specific steviol glycosides to achieve a desired sensory profile. Sensory panels are a scientific and reproducible method that is essential to the food and beverage industry. A sensory panel involves a group of two or more individual panelists. Panelists are instructed according to industry-recognized practices to avoid the influence of personal subjectivity and strengthen reproducibility. For example, panelists may objectively evaluate sensory attributes of a tested product but may not provide subjective attributes such as personal preference. In various aspects, the sensory panel can be conducted with two, three, four, five, six, or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e.. 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 15, where 0 corresponds to the absence of the attribute, while 6, 9, or 15, respectively, corresponds to the upper bound extreme occurrence of the attribute. The panel may use a roundtable consensus approach, or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g., saltiness, soumess, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

As used herein, “roundtable consensus approach” refers to the sensory panel assay methodology wherein panelists discus sensory attributes and intensities before mutually agreeing on an intensity score and attribute characterization for the particular sensory attribute(s) being assayed. A sensory panel using a roundtable consensus approach may include 2, 3, 4, 5, 6, or more panelists. Consensus intensity scales can range from 0 to 6 (i.e., 0=not detected, 1=trace, 2=slight, 3=moderate, 4=definite, 5=strong, 6=extreme) or 0 to 9 (i.e., 0=not detected, 1=trace, 2=faint, 3=slight, 4=mild, 5=moderate, 6=definite, 7=strong, 8=very strong, 9=extreme). For a given set of samples, the panelists will identify and agree on a lexicon of sensory attribute, including, if applicable, reference or standardized samples (also referred to as sensory anchors) for a particular sensory attribute. The reference sample(s) used for a given sensory attribute(s) will depend on the samples being assayed and the lexicon of sensory attributes determined by the panel. One of skill in the art will recognize the appropriate lexicon and reference or standard samples necessary for sensory assessment of a given sample(s).

In some aspects, the samples are scored and evaluated by panelists independently after panelists have agreed upon or been instructed in a lexicon of sensory attributes and intensity scores including, if applicable, assay specific calibration on reference samples (also referred to as sensory anchors) for a particular sensory attribute. Examples of common reference samples are described below. Panelists may evaluate samples in replicate and may be blinded to the samples they are testing. Samples being tested may be provided to the panelists randomly or in a sequential order. In some aspects, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

A sensory attribute(s) of a given composition may be evaluated in comparison to one or more reference or anchor samples. For example, sodium chloride solutions can be used by experienced panelists as saltiness anchors to assess the relative intensity of saltiness for a given composition; sucrose solutions can be used by experienced panelists as sweetness anchors to assess the relative intensity of sweetness for a given composition; citric acid solutions can be used by experienced panelists as sourness anchors to assess the relative intensity of sourness for a given composition; caffeine solutions can be used by experienced panelists as bitterness anchors to assess the relative intensity of bitterness for a given composition; and monosodium glutamate (MSG) solutions can be used by experienced panelists as umami anchors to assess the relative intensity of umami for a given composition. Experienced panelists can be presented with a solution to assess sensory attributes, e.g., 10-20 mL of a sample. Panelists will dispense approximately 3-4 mL of each solution into their own mouths, disperse the solution by moving their tongues, and record a value for the particular sensory attribute being tested. If multiple solutions are to be tested in a session, the panelists may cleanse their palates with water between samples. For example, a roundtable assessment of saltiness, sweetness, sourness, umami, and the like can assign a scale of 0 to 9 with, e.g., a score of 0 indicating no saltiness and a score of 9 indicating extreme saltiness (0=not detected, 1=trace, 2=faint. 3=slight. 4=mild, 5=moderate, 6=definite, 7=strong, 8=very strong. 9=extreme). Equivalent scales and methodologies can be used for sweet, bitter, sour, and umami sensory attributes.

Sourness of a composition can be tested by a panel of at least two panelists. The panelists can use a standard range of 0.035% (wt). 0.05% (wt). 0.07% (wt). 0.15% (wt), and 0.2% (wt) citric acid solutions in water corresponding to a sourness intensity value of 2, 3, 5, 10, and 15, respectively. A skilled artisan will recognize that depending on the sample/composition being tested, the number and range of standard solutions may be changed (e.g., using only the solutions corresponding to the 2 and 7 sourness intensity values). For each test composition, the panelists dispense each composition (approximately 2-5 mL of liquid compositions or solutions prepared with water, or 5-10 g of solid compositions) into their own mouths, disperses the composition by moving their tongues/chewing, and records a sourness intensity value between 0 and 15 for each composition based on comparison to the aforementioned standard citric acid solutions. Between tasting compositions, the panelists are able to cleanse their palates with water. The panelists also can taste the standard 0.035%. 0.05%, 0.07%, 0.15%, and 0.2% citric acid solutions ad libitum between tasting test solutions to ensure recorded sourness intensity values are accurate against the scale of the standard citric acid solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sourness Intensity Test.”

Bitterness of a composition can be tested by a panel of at least two panelists. The panelists can use a standard range of 0.0125% (wt), 0.01875% (wt), 0.025% (wt), 0.031% (wt), 0.07% (wt), and 0.12% (wt) caffeine solutions in water corresponding to a bitterness intensity value of 2, 3, 4, 5, 10, and 15, respectively. A skilled artisan will recognize that depending on the sample/composition being tested, the number and range of standard solutions may be changed (e.g., using only the solutions corresponding to the 2, 3, and 5 bitterness intensity values). For each test composition, the panelists dispense each composition (approximately 2-5 mL of liquid compositions or solutions prepared with water, or 5-10 g of solid compositions) into their own mouths, disperses the composition by moving their tongues/chewing, and records a bitterness intensity value between 0 and 15 for each composition based on comparison to the aforementioned standard caffeine solutions. Between tasting compositions, the panelists are able to cleanse their palates with water. The panelists also can taste the standard 0.0125%, 0.01875%, 0.025%, 0.031%, 0.07%, and 0.12% caffeine solutions ad libitum between tasting test solutions to ensure recorded bitterness intensity values are accurate against the scale of the standard caffeine solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Bitterness Intensity Test.”

Sweetness of a composition can be tested by a panel of at least two panelists. The panelists can use a standard range of 2% (wt), 5% (wt), 8% (wt). 10% (wt), and 15% (wt) sucrose solutions corresponding to a sweetness intensity value of 2, 5, 8, 10, and 15, respectively. A skilled artisan will recognize that depending on the sample/composition being tested, the number and range of standard solutions may be changed (e.g., using only the solutions corresponding to the 2, 5, and 8 sweetness intensity values). For each test composition, the panelists dispense each composition (approximately 2-5 mL of liquid compositions or solutions prepared with water, or 5-10 g of solid compositions) into their own mouths, disperses the composition by moving their tongues/chewing, and records a sweetness intensity value between 0 and 15 for each composition based on comparison to the aforementioned standard sucrose solutions. Between tasting compositions, the panelists are able to cleanse their palates with water. The panelists also can taste the standard 2%, 5%, 8%, 10%, and 15% sucrose solutions ad libitum between tasting test solutions to ensure recorded sweetness intensity values are accurate against the scale of the standard sucrose solutions. The temperature at which the test is conducted may be specific to the sample beginning tested, e.g., samples may be tested at 22° C. (e.g., room temperature), at 0° C. (e.g., for frozen samples), or between 60-80° C. (e.g., a cooked sample served warm). One skilled in the art will recognize the appropriate temperature for testing a given sample. This test is referred to herein as the “Standardized Sweetness Intensity Test.”

Temporal aspects of taste, flavor, and/or aromatic properties of compositions described herein may be evaluated by any suitable means known in the art. Temporal aspects, also referred to as time attributes, may include, but are not limited to, time to taste/flavor/aroma onset, time at max taste/flavor/aroma, and taste/flavor/aroma linger. Time to taste/flavor/aroma onset refers to the time (in seconds) it takes from the time the sample is put in the mouth until the given taste/flavor/aroma is perceived. Time to taste/flavor/aroma onset may be measured by putting a sample in the mouth and swallowing (not holding in the mouth or spitting), starting a timer when the sample is put in the mouth, and noting the time when the given taste/flavor/aroma is perceived. Time at max flavor/taste/aroma is defined as the time (in seconds) the sample remains at the highest intensity of the given taste/flavor/aroma. Time at max taste/flavor/aroma may be measured by putting a sample in the mouth and swallowing (not holding in the mouth or spitting), starting a timer when peak intensity of the taste/flavor/aroma begins and noting the time when the taste/flavor/aroma intensity begins to decline. Taste/flavor/aroma linger is defined as the time (in seconds) from when the taste/flavor/aroma starts to drop from peak intensity until the given taste/flavor/aroma is no longer discerned. Taste/flavor/aroma linger may be measured by putting a sample in the mouth and swallowing (not holding in the mouth or spitting), starting a timer when the peak intensity of the taste/flavor/aroma begins to decline, and noting the time when the taste/flavor/aroma is no longer perceived.

A control sample is typically used as a reference point or for comparison purposes. For example, a control sample can be used to qualify the sensory perception (e.g., sweetness or other sensory attribute) of Reb EE. The control sample can be a composition such as a sweetener composition as described herein, but without the presence of Reb EE. Other than the sweetener (e.g., Reb EE), the control sample is otherwise the same, and it should contain the same component(s) and other ingredients at the same relative concentrations. Other standard samples are commonly used in sensory panels, for example standard samples used to evaluate intensity of sensory attributes as outlined above. In other aspects, the control sample may be a modified control sample which contains a different sweetener, such as another steviol glycoside with a known sweetness profile. Exemplary sweeteners used as control samples include Reb A and Reb D/M.

This disclosure is not limited to sensory testing by experienced or trained panelists. For example, it is possible to utilize untrained and inexperienced panelists. However, in the case of untrained and inexperienced panelists, a greater number of these panelists is usually necessary to provide reproducible results, which will typically focus on subjective attributes such as preference or overall liking. Similarly, untrained, and inexperienced panelists may be asked to evaluate relative changes in a given sensory attribute between two samples. For example, if a particular sample is more or less salty, more or less sweet, more or less bitter, etc., than a reference sample.

An exemplified sensory assay and test criteria for further sensory attributes are described in the Examples provided in this disclosure.

The present invention can be better understood by reference to the following examples which are offered by way of illustration. The present invention is not limited to the examples given herein.

### EXAMPLES

### Materials and Methods

Table 2 lists the tested materials and source of various components.

TABLE 2

| Component | Ingredients | Source |
|---|---|---|
| Reb EE | >95% pure Reb EE | Cargill, Inc. |
| | | (Wayzata, MN) |
| Reb A | >95% pure Reb A | Cargill, Inc. |
| Reb D/M | ≥85% Reb M, ~3-15% Reb D | Cargill, Inc. |
| Reb V2 | >95% pure Reb V2 | Cargill, Inc. |

Assays were carried out to characterize the sensory attributes, e.g., sweetness profile, of aqueous solutions of samples. Sensory attributes of the compositions were tested by a panel of individuals that are experienced in sensory testing. The experienced panelists assessed sensory attributes such as, but not limited to, bitterness, metallic notes, mouth drying, sweetness intensity, and sweetness linger. The panelists compared the sweeteners against Reb A and Reb D/M. To test each composition, the experienced panelists dispensed approximately 2-4 fl oz of each sample or solution into their own mouths, dispersed the solution by moving their tongues, and individually recorded a sensory attribute scale value. Between tasting solutions, the panelists were able to cleanse their palates with water and/or rice crackers.

### Example 1—Reb EE

Reb EE was isolated and its structure was determined using high resolution accurate mass (HRAM) and nuclear magnetic resonance (NMR).

Reb EE was extracted from dried Stevia leaf using hot water. The hot water extract was then freeze-dried to a powder. The powder was then solubilized with 50% ethanol and purified using a C18 prep column via Prep LC, utilizing a water and methanol gradient. The resulting fractions for each steviol glycoside were pooled from multiple injections and evaporated in a rotary evaporator to remove methanol. The low methanol solution was then freeze-dried to a powder. The pooled fraction powder was then solubilized with 50% ethanol and purified further using Prep LC until the desired purity (>95%) was reached (usually taking 3-5 iterations, depending on the steviol glycoside). Finally, the pooled fraction powder was freeze-dried three consecutive times to ensure no residual solvent is present in the powder.

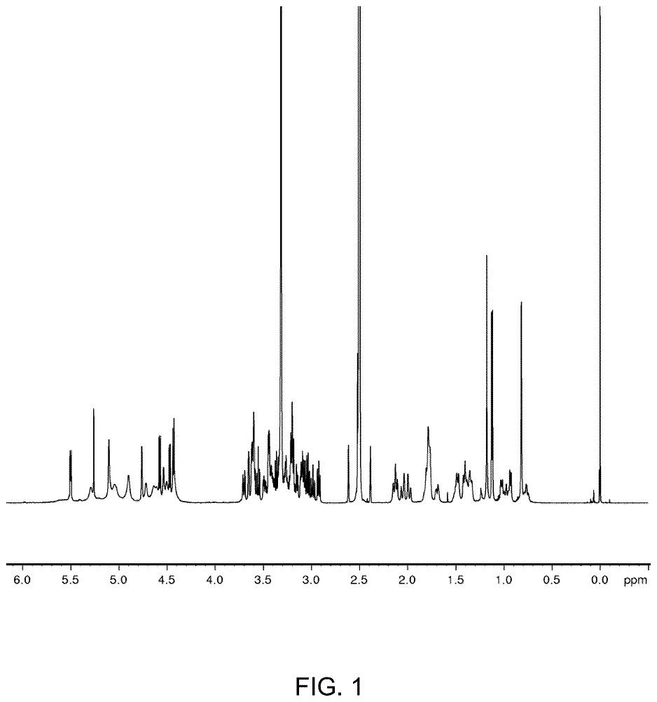

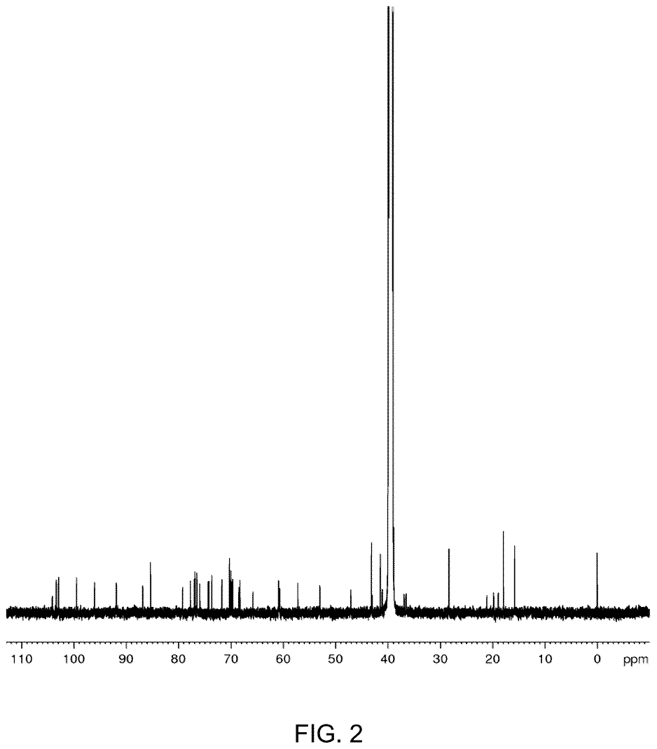

The sample was prepared by dissolving the sample in 0.6 mL dimethylsulfoxide DMSO-d₆. A set of 1- and 2-dimensional ¹H-NMR and ¹³C-NMR spectra were recorded to characterize the sample. The NMR spectra are shown in FIGS. 1 (¹H-NMR) and 2 (¹³C-NMR) and FIG. 2 shows a summary of the NMR data used to confirm the structure of Reb EE.

The ¹H and ¹³C NMR spectral data indicated the presence of a steviol core structure containing three (3) β-glucose moieties, one (1) α-rhamnose moiety and one (1) β-xylose moiety. There are two (2) β-glucose units and one (1) β-xylose moiety linked via the steviol C-13 site; Glc2 is 2,3-branched (Glc4(β1→3)Xyl3(β1→2)Glc2(β1→C-13(steviol)). There is one (1) β-glucose unit and one (1) α-rhamnose unit linked via the steviol C-19 site: Rha5 is linked to Glc1 via the 2-position (Rha5(α1→2)Glc1(β1→C-19(steviol)). The structure was determined to have the structure of Formula I:

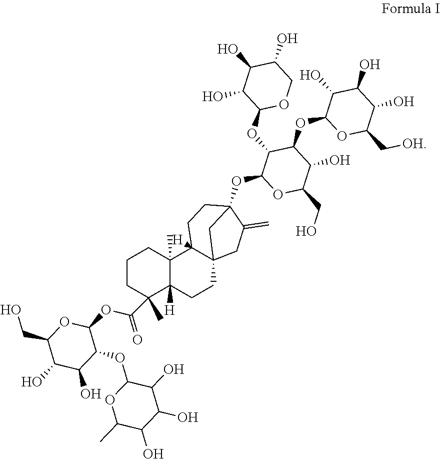 [SMILES: C=C1C[C@@]23CC[C@H]4[C@@](C)(CCC[C@@]4(C)C(=O)O[C@@H]4O[C@H](CO)[C@@H](O)[C@H](O)[C@H]4OC4OC(C)C(O)C(O)C4O)[C@@H]2CC[C@]1(O[C@@H]1O[C@H](CO)[C@@H](O)[C@H](O[C@@H]2O[C@H](CO)[C@@H](O)[C@H](O)[C@H]2O)[C@H]1O[C@@H]1OC[C@@H](O)[C@H](O)[C@H]1O)C3]

### Example 2—Sensory Attributes of Reb EE Solutions

Assays were carried out to characterize the sensory attributes of aqueous solutions. Sensory attributes were analyzed by a panel of four individuals using a roundtable consensus approach. All panelists used the assay method described above. The panelists provided a descriptive analysis of the samples. The sensory attributes of Reb D/M are known, and thus Reb D/M was used as a comparative sample. Sample solutions were prepared diluting in reverse osmosis (RO) water as indicated in Table 3. The sensory assay results are reported in Table 4.

TABLE 3

| Sample | Steviol Glycoside | Concentration |
|---|---|---|
| 1 | Reb EE | 430 ppm |
| 2 (comparative sample) | Reb D/M | 430 ppm |

TABLE 4

| Sample | Sensory Attribute Comments |
|---|---|
| 1 | Sweetness: Less sweet (about ~1-1.5 SEV |
| | less) than Sample 2 (Reb D/M). |
| | Off-tastes: Faint metallic. Mild bitterness. |
| 2 | Sweetness: Sweetness profile typical of Reb D/M |
| (comparative sample) | with significant sweetness linger. |
| | Off-tastes: Typical Reb D/M metallic taste. |

### Example 3—Sensory Attributes of Reb V2 Solutions

Assays were carried out to characterize the sensory attributes of aqueous solutions. Sensory attributes were analyzed by a panel of four individuals using a roundtable consensus approach. All panelists used the assay method described above. The panelists provided a descriptive analysis of the samples. The sensory attributes of Reb A and Reb D/M are known, and thus Reb A and Reb D/M were used as comparative samples. The sweetness profile of Reb A is described in the art, for example in DuBois et al. (“Concentration—Repose Relationship of Sweeteners,” Sweeteners: Discovery, Molecular Design, and Chemoreception, Chapter 20, pages 261-276, American Chemical Society 1991). Sample solutions were prepared diluting in reverse osmosis (RO) water as indicated in Table 5. The sensory assay results are reported in Table 6.

TABLE 5

| Sample | Steviol Glycoside | Concentration |
|---|---|---|
| 3 | Reb V2 | 500 ppm |
| 4 (comparative sample) | Reb A | 500 ppm |
| 5 (comparative sample) | Reb D/M | 500 ppm |

TABLE 6

| Sample | Sensory Attribute Comments |
|---|---|
| 3 | Sweetness: Higher peak sweetness than Sample 5 (Reb D/M). Slight |
| | delay in onset (less delay than Sample 5 (Reb D/M)), very rapid rise, |
| | and some linger but not as much as Sample 5 (Reb D/M) |
| | Off-tastes: Very faint bitterness. Quite clean sweetness. |
| 4 | Sweetness: Sweetness profile typical of Reb A. |
| (comparative sample) | Off-tastes: Typical Reb A bitterness, metallic taste. |
| 5 | Sweetness: Sweetness profile typical of Reb D/M, which includes |
| (comparative sample) | longer sweetness linger than Reb A. |
| | Off-tastes: Typical Reb M metallic taste. |

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A sweetener composition comprising a sweetening amount of rebaudioside EE (Reb EE), wherein Reb EE is a steviol glycoside compound of Formula I:

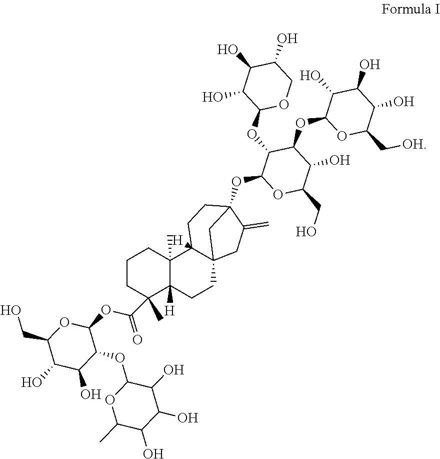 [SMILES: C=C1C[C@@]23CC[C@H]4[C@@](C)(CCC[C@@]4(C)C(=O)O[C@@H]4O[C@H](CO)[C@@H](O)[C@H](O)[C@H]4OC4OC(C)C(O)C(O)C4O)[C@@H]2CC[C@]1(O[C@@H]1O[C@H](CO)[C@@H](O)[C@H](O[C@@H]2O[C@H](CO)[C@@H](O)[C@H](O)[C@H]2O)[C@H]1O[C@@H]1OC[C@@H](O)[C@H](O)[C@H]1O)C3]

2. The composition of claim 1, wherein Reb EE is present in an amount such that when the sweetener composition is added to an aqueous solution at a concentration such that the solution comprises 500 ppm Reb EE, the solution has a sweetness between 5.0 and 8.0 SEV.

3. (canceled)

4. The composition of claim 1 wherein the sweetener composition comprises about 0.04 wt % to 95 wt %; of Reb EE based on total weight of the composition.

5. The composition of claim 1 further comprising one or more steviol glycoside compounds in addition to Reb EE.

6. The composition of claim 5, wherein the one or more additional steviol glycoside compounds are selected from the group consisting of steviolmonoside, steviolbioside, stevioside, rebaudioside A (Reb A), rebaudioside B (Reb B), rebaudioside C (Reb C), rebaudioside D (Reb D), rebaudioside DG (Reb DG), rebaudioside E (Reb E), rebaudioside F (Reb F), rebaudioside J (Reb J), rebaudioside M (Reb M), rebaudioside N (Reb N), rebaudioside O (Reb O), rebaudioside V2 (Reb V2), rubusoside, dulcoside A, steviol-13-monoside, steviol-19-monoside, 13-[(β-D-glucopyranosyl)oxy)kaur-16-en-18-oic acid 2-O-β-D-glucopyranosyl-p-D-glucopyranosyl ester, and combinations thereof.

7. The composition of claim 5, wherein the one or more additional steviol glycoside compounds are selected from the group consisting of Reb A, Reb D, Reb DG, Reb J, Reb M, Reb N, Reb O, Reb V2, and combinations thereof.

8. The composition of claim 5, wherein the one or more additional steviol glycoside compounds are selected from the group consisting of Reb D, Reb M, and combinations thereof.

9. The composition of claim 1 wherein Reb EE is present in an amount of about 0.5 wt % to 100 wt % or about 0.5 wt % to about 10 wt % based on total amount of steviol glycosides in the composition.

10. The composition of claim 5, wherein the one or more additional steviol glycoside compounds are present in an amount of 0.1 wt % to about 99.5 wt % based on total amount of steviol glycosides in the composition.

11. The composition of claim 5 further comprising a bulking agent, a plasticizer, an emulsifier, a flavoring, or a combination thereof.

12. The composition of claim 1 wherein the composition is an aqueous solution comprising about 1 ppm to about 50,000 ppm of Reb EE.

13. The composition of claim 5, wherein the composition is an aqueous solution comprising about 1 ppm to about 500,000 ppm of total steviol glycosides.

14. The composition of claim 5, wherein when the sweetener composition is added to an aqueous solution at a concentration such that the solution comprises 400 ppm Reb EE, the solution has i) reduced bitterness relative to an equivalent solution prepared with Reb A; ii) reduced metallic notes relative to an equivalent solution prepared with Reb M; and/or iii) reduced sweetness linger relative to an equivalent solution prepared with a combination of Reb D and Reb M.

15. A food or beverage product containing the sweetener composition of claim 1.

16. A beverage product or concentrate comprising Reb EE, wherein Reb EE is a steviol glycoside compound having a structure of Formula I:

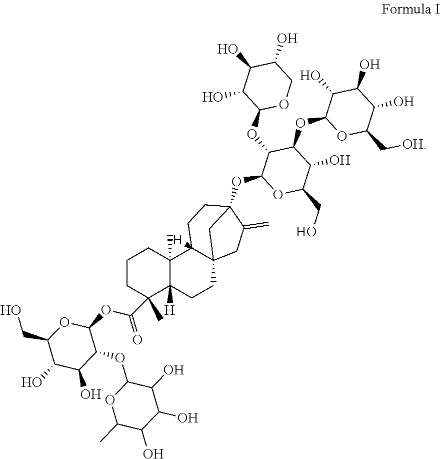 [SMILES: C=C1C[C@@]23CC[C@H]4[C@@](C)(CCC[C@@]4(C)C(=O)O[C@@H]4O[C@H](CO)[C@@H](O)[C@H](O)[C@H]4OC4OC(C)C(O)C(O)C4O)[C@@H]2CC[C@]1(O[C@@H]1O[C@H](CO)[C@@H](O)[C@H](O[C@@H]2O[C@H](CO)[C@@H](O)[C@H](O)[C@H]2O)[C@H]1O[C@@H]1OC[C@@H](O)[C@H](O)[C@H]1O)C3]

17. The beverage product or concentrate of claim 16, wherein the beverage comprises about 1 ppm to about 50,000 ppm of Reb EE.

18. The beverage product or concentrate of claim 16, wherein the beverage comprises about 50 ppm to about 500,000 ppm of total steviol glycosides.

19. (canceled)

20. A method for sweetening a food or beverage product, the method comprising: adding the sweetener composition of claim 1 to the food or beverage product, wherein sweetness of the food or beverage is higher than sweetness of the food or beverage prior to addition of sweetener composition.

21. (canceled)

22. (canceled)

23. (canceled)

24. A composition comprising Reb EE and at least one additional steviol glycoside, wherein Reb EE is a steviol glycoside compound of Formula I: 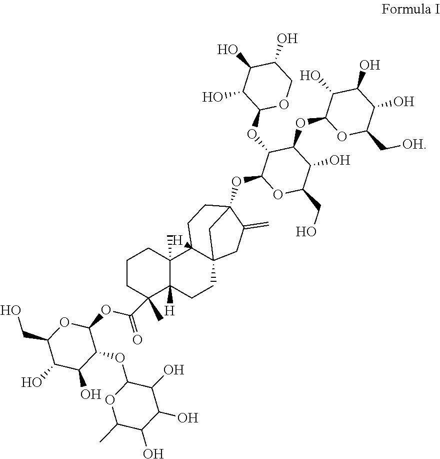 [SMILES: C=C1C[C@@]23CC[C@H]4[C@@](C)(CCC[C@@]4(C)C(=O)O[C@@H]4O[C@H](CO)[C@@H](O)[C@H](O)[C@H]4OC4OC(C)C(O)C(O)C4O)[C@@H]2CC[C@]1(O[C@@H]1O[C@H](CO)[C@@H](O)[C@H](O[C@@H]2O[C@H](CO)[C@@H](O)[C@H](O)[C@H]2O)[C@H]1O[C@@H]1OC[C@@H](O)[C@H](O)[C@H]1O)C3]
